(19) United States
(12) Patent Application Publication
(10) Pub. No.: US 2004/0196751 A1
(43) Pub. Date: Oct. 7, 2004

(54) METHOD OF CONTROLLING THE FORCE OF THE SLED MOTOR IN AN OPTICAL DISK DRIVE

(76) Inventors: Jen-Yu Hsu, Taipei City (TW); Ren-Chien FU, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,755

(22) Filed: Mar. 23, 2004

(30) Foreign Application Priority Data
Apr. 2, 2003 (TW) 92107679

(51) Int. Cl. G11B 7/085

(52) U.S. Cl. 369/30.17

(57) ABSTRACT

After an optical disk drive is powered on, a predetermined force is provided to a sled motor. When the predetermined force is provided, a duration of the pickup head module sliding from an inner region to an outer region of an optical disk is measured. A correction coefficient is obtained from the ratio of the measured duration and an ideal duration. Thereafter the force of the sled motor is corrected by the correction coefficient. This reduces differences of reading/writing time among individual optical disk drives.

### BACKGROUND OF INVENTION

1. Field of the Invention

The present invention relates to a method of controlling the force of a sled motor in an optical disk drive, and more particularly, to a method which provides an individual optical disk drive with a learning process so that an pickup head module has the same moving time within the allowable movement range.

2. Description of the Prior Art

A typical optical disk drive uses a stepping motor as a sled motor. The stepping motor is used for driving the pickup head module to move within an allowable movement range. After the optical disk drive is powered on, the optical disk drive executes a start up procedure, which includes initiating system parameters of a servo, etc. In first step of initiating the servo, the sled motor drives the pickup head module to move to the inner region of an optical disk. Then the optical pickup head starts to seek and access the optical disk. When the optical disk drive seeks and accesses the optical disk, the moving speed of the pickup head module affects the reading or writing speed of the optical disk drive. Since typical optical disk drives use stepping motors as sled motors, the moving time of the pickup head module in an individual optical disk drive is substantially the same as in other drives using the stepping motor.

However, some optical disk drives of specific types, such as slim-type optical disk drives, usually use DC motors as sled motors in order to reduce the dimensions of the drives. Since the friction coefficients between a rack and a lead screw of the pickup head module are different among individual optical disk drives, it is not easy to control the force of the sled motor. Thus, how to make each pickup head module have the same moving time within the allowable movement range among many individual optical disk drives is an important issue.

### SUMMARY OF INVENTION

It is therefore a primary objective of the claimed invention to provide a method of controlling the force of the sled motor to solve the above-mentioned problem. The claimed invention maintains the moving speed of the pickup head module at the same speed when the pickup head module moves within the allowable range. This reduces the differences in reading/writing time among individual optical disk drives.

It is an advantage of the claimed invention that the method can control the force of the sled motor so that each pickup head module has the same moving time within the allowable movement range. After the optical disk drive is initially powered on, a predetermined force is provided to the sled motor. A duration of the pickup head module moving a predetermined distance when the predetermined force is provided is measured. A correction coefficient is obtained according to the measured duration and an ideal duration. Then, the force of the sled motor is corrected according to the correction coefficient.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of an inner structure of an optical disk drive.

FIG. 2 is a flowchart showing optical disk drive fabrication steps.

FIG. 3 is a flowchart showing how the optical disk drive of the present invention corrects the force of the sled motor when initially powered on.

### DETAILED DESCRIPTION

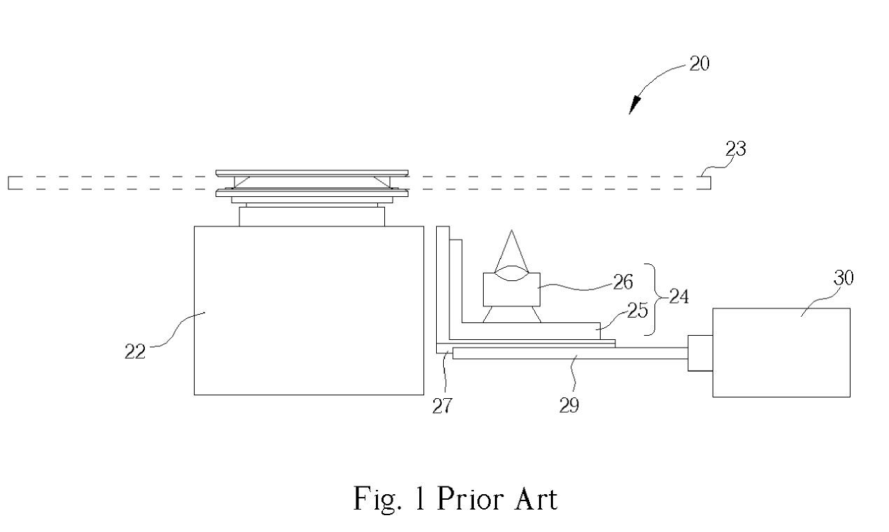

Please refer to FIG. 1. FIG. 1 is a schematic diagram of an inner structure of an optical disk drive 20. The optical disk drive 20 includes a spindle motor 22, a pickup head module 24, and a sled motor 30. The spindle motor 22 controls an optical disk 23 to rotate. The pickup head module 24 includes a sledge 25, an optical pickup head 26, and a rack 27. A lead screw 29 of the sled motor 30 engages with the rack 27 of the pickup head module 24. Rotating the sled motor 30 drives the pickup head module 24 to move.

Among individual optical disk drives, due to the inherent properties of mechanism, the friction between the lead screw 29 and the rack 27 differs. When using a stepping motor as the sled motor 30, the moving time and moving speed of the pickup head module 24 has less variation between optical disk drives because the pickup head module 24 is driven digitally. When using a smaller DC motor as the sled motor 30, it is difficult to control the force of the sled motor 30 and to make the pickup head module 24 have a consistent moving time among different drives because the optical pickup head is driven analogically.

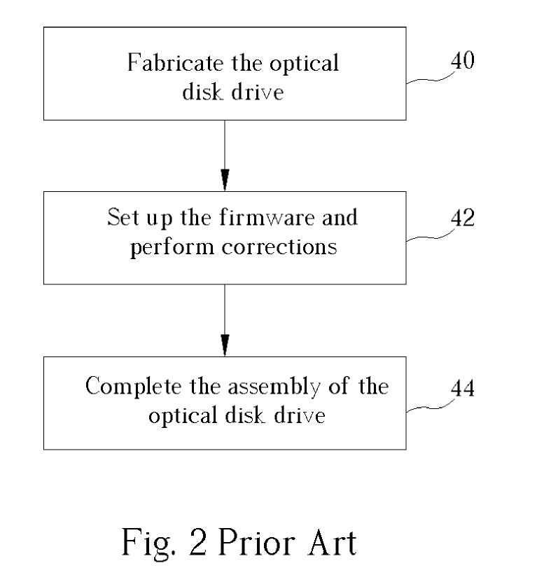

Please refer to FIG. 2. FIG. 2 is a fabrication process of optical disk drives.

Step 40: Fabricate the optical disk drive. That is, assemble the mechanical parts and PCB (printed circuit board) pieces of the optical disk drive together.

Step 42: Set up the firmware and perform corrections. The functions of the hardware is programmed and stored into a ROM or into a re-programmable IC in this step. Some tests or corrections can also be done by executing the firmware.

Step 44: Complete the assembly of the optical disk drive.

In this embodiment, the present invention uses a learning process to control the force of the sled motor by executing the firmware.

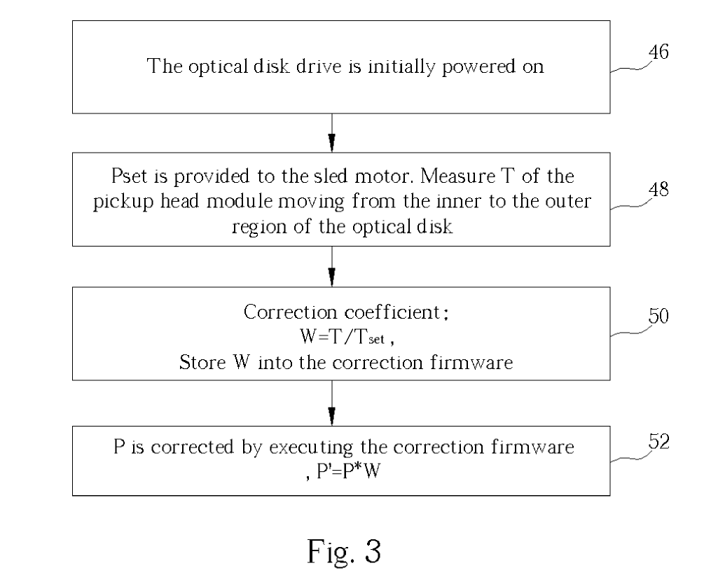

Please refer to FIG. 3. FIG. 3 is a flowchart showing how the optical disk drive of the present invention corrects the force of the sled motor when the optical disk drive is initially powered on. In this embodiment, a voltage or a current is adjusted to change the magnitude of the force.

Step 46: The optical disk drive is initially powered on.

Step 48: Because the optical disk drive executes the start up procedure (i.e. the system parameters of the servo are initiated), the pickup head module moves to the inner region of the optical disk. A predetermined force Pₛₑₜ is provided to the sled motor driving the pickup head module to move from the inner region to the outer region of the optical disk. A duration T of the pickup head module moving from the inner region to the outer region of the optical disk is then measured.

Step 50: The duration Tₛₑₜ is the ideal duration of the pickup head module moving from the inner region to the outer region of the optical disk. The correction coefficient W (W=T/Tₛₑₜ) is calculated. Thereafter the correction coefficient W is stored into the correction firmware.

Step 52: The force P of the sled motor is corrected to P=P*W by executing the correction firmware.

Step 46 to 52 provide a learning process to individual optical disk drives so that each pickup head module has the same moving time within the allowable movement range. It should be noted that the inner and outer regions can be tracks or other established areas of a disk. The above process reduces differences of reading/writing time among individual optical disk drives, and makes a group of optical disk drives more consistent in operation.

In summary, the present invention controls the force of the sled motor by executing the correction firmware before a drive leaves the factory. After the optical disk drive is initially powered on, the pickup head module is driven to move from an inner region to an outer region of the optical disk by the correction firmware and a corresponding duration of movement is measured. A correction coefficient is a ratio of the measured duration and an ideal duration, and is stored into the correction firmware. The force of the sled motor is adjusted according to the correction coefficient. Therefore, the moving speed of optical pickup heads among individual optical disk drives is the same. This reduces differences of reading/writing time among individual optical disk drives.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of controlling the force of a sled motor in an optical disk drive, the method comprising:
providing a predetermined force to the sled motor after the optical disk drive is powered on;
measuring a duration of an pickup head module moving a predetermined distance when the predetermined force is provided;
obtaining a correction coefficient according to the measured duration and an ideal duration; and
correcting the force of the sled motor according to the correction coefficient.

2. The method of claim 1 wherein the optical disk drive is a slim-type optical disk drive.

3. The method of claim 1 wherein the sled motor is a DC motor.

4. The method of claim 1 wherein the predetermined distance is less than or equal to an allowable movement range of the pickup head module.

5. The method of claim 1 wherein the correction coefficient is a ratio of the measured duration and the ideal duration.

6. The method of claim 1 wherein the force of the sled motor is multiplied by the correction coefficient to correct the force.

7. A method of controlling the force of a sled motor in an optical disk drive, the method comprising:
providing a predetermined force to the sled motor after the optical disk drive is powered on;
recording a first time and a second time when an pickup head module reaches the first position and the second position respectively;
obtaining a measured duration according to the first time and the second time;
obtaining a correction coefficient according to the measured duration and an ideal duration; and
correcting the force of the sled motor according to the correction coefficient.

8. The method of claim 7 wherein the optical disk drive is a slim-type optical disk drive.

9. The method of claim 7 wherein the sled motor is a DC motor.

10. The method of claim 7 wherein the distance between the first position and the second position is less than or equal to an allowable movement range of the pickup head module.

11. The method of claim 7 wherein the correction coefficient is a ratio of the measured duration and the ideal duration.

12. The method of claim 7 wherein the force of the sled motor is multiplied by the correction coefficient to correct the force.
